(19) United States
(12) Patent Application Publication
(10) Pub. No.: US 2013/0144457 A1
(43) Pub. Date: Jun. 6, 2013

(54) SERVER SYSTEM FOR UPDATING HEAT DISSIPATION SOLUTION

(71) Applicants: HONG FU JIN PRECISION INDUSTRY (Shenzhen, Shenzhen City (CN); HON HAI PRECISION INDUSTRY CO., LTD., Tu-Cheng (TW)

(72) Inventors: WEI-DONG CONG, Shenzhen City (CN); KANG WU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/669,470

(22) Filed: Nov. 6, 2012

(30) Foreign Application Priority Data
Dec. 1, 2011 (CN) 201110392888.4

(51) Int. Cl. G05D 23/00

(52) U.S. Cl. 700/299

(57) ABSTRACT

A server system for improving maintainability includes a rack server comprising at least one server and a heat dissipation system comprising at least one fan, a controller is configured to store a plurality of heat dissipation solutions and an detection program, the controller configured to control a rotate speed of the at least one fan, and a USB converter is connected to the at least one server and the controller. When the controller detects the stored heat dissipation solution does not match with the one server with the detection program, an updated dissipation solution is written in the controller.

### BACKGROUND

1. Technical Field

The present disclosure relates to a server system for updating heat dissipation solution.

2. Description of Related Art

Server systems are basic devices in Internet communication. A plurality of 1U (U=1.75 inches) servers are inserted in a rack to constitute a rack-mounted server system. Various types of 1U servers, such as different models, different power costs, are required in the rack-mounted server system. Such different types of 1U servers need different heat dissipation solutions in form of computerized code that are stored in firmware of fan control circuits of the server system. If a new type of server is inserted in the rack, the fan control circuit may need to be removed from the rack to allow a new heat dissipation solution corresponding to the new type of server to be written into the firmware. Thus, maintainability of the server system is low.

Therefore, a server system for updating heat dissipation to overcome the above described shortcoming is desired.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a block diagram of a server system according to an exemplary embodiment of the present disclosure.

FIG. 2 is a block diagram of a server system according to another exemplary embodiment of the present disclosure.

FIG. 3 is a flowchart showing a method for controlling of the server system of the present disclosure of FIG. 1.

### DETAILED DESCRIPTION

Reference will be made to the drawings to describe various embodiments in detail.

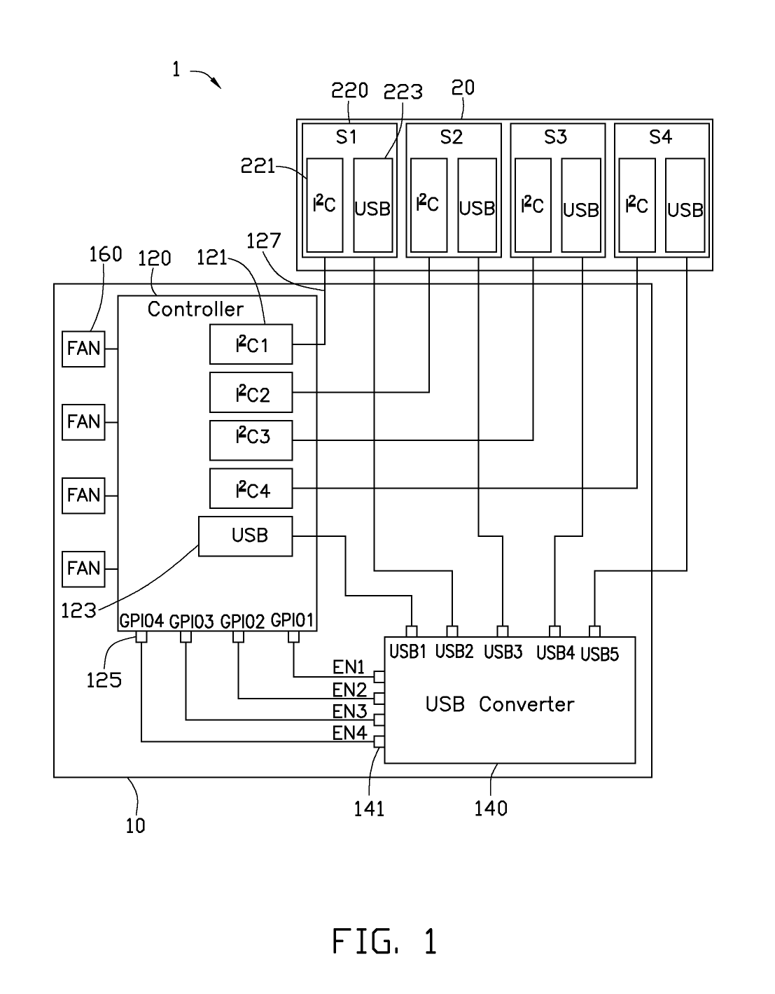

FIG. 1 illustrates a block diagram of a server system 1 according to an exemplary embodiment of the present disclosure. The server system 1 includes a heat dissipation system 10 and a rack server 20. The heat dissipation system 10 can be, for example, configured to set and monitor a dissipating heat solution (e.g., computerized code that controls various hardware and software functions for the rack server 20) of the rack server 20.

The heat dissipation system 10 is arranged in a rack of the rack server 20. The rack server 20 includes at least one server 220 with 1U size. Each server 220 includes a first Universal Serial Bus (USB) interface 223. The heat dissipation system 10 includes a controller 120, a USB converter 140, and at least one fan 160. One fan 160 configured to dissipate heat for the at least one server 220. The controller 120 includes a second USB interface 123, and is directly electrically connected to the at least one server 220 via I²C bus lines 127. The second USB interface 123 is electrically connected to the first interfaces 223 of the at least one server 220 via the USB converter 140.

The controller 120 configured to store at least one heat dissipation solution to control a rotation speed of the at least one fan 160, where the one heat dissipation solution corresponds to one server 220 and the fan 160. A detection program comprising computerized code is also stored in the controller 120. The controller 120 detects whether a stored heat dissipation solution, implemented by the controller 120 to control a rotate speed of one fan 160, matches with a type of the server 220 which includes model of the server, power cost of the server and so on using the detection program. When the stored heat dissipation program does not match with the type of the server 20, the controller generates a control signal to the USB converter 140. The USB converter 140 enables communication connections between the first USB interface 223 of the server 220 and the second USB interface 123 of the controller 120, such that the server 220 updates the stored heat dissipation solution stored in the controller 120. Then, a fan 160 corresponding to the server 220 changes its working state, such as changes a rotation speed of the fan 160, according to the updated heat dissipation solution.

In the embodiment, the rack server 20 includes four servers 220, labeled as S1, S2, S3 and S4, respectively. It is to be understood, the present disclosure is not limited to the rack server 20 including four servers 220, but may include at least one server 220, or more than four servers. In the embodiment, each server in the rack server 20 stores a heat dissipation solution for itself.

The controller 120 further includes four Inter-Integrated Circuit (I²C) interfaces 121. The four I²C interfaces are labeled as I²C1, I²C2, I²C3 and I²C4 corresponding to the servers S1, S2, S3 and S4. Each server 220 further includes an I²C interface 221 corresponding to a register or a memory in the server 220. The four I²C interfaces I²C1, I²C2, I²C3 and I²C4 connect to the I²C interface of the server S1, S2, S3 and S4 via four I²C buses 127 respectively.

The USB converter 140 includes five USB interfaces USB1, USB2, USB3, USB4 and USB5 and four enable interfaces 141 labeled as EN1, EN2, EN3 and EN4, respectively. The USB interface USB1 as a main USB interface is electrically coupled to the second USB interface 123 of the controller 120. The USB interfaces USB2, USB3, USB4 and USB5 are correspondingly connected to the first USB interfaces 223 of the servers S1, S2, S3 and S4. The controller 120 further includes four General Purpose Input Output (GPIO) interfaces 125, labeled as GPIO1, GPIO2, GPIO3 and GPIO4. The four GPIO interfaces GPIO1, GPIO2, GPIO3 and GPIO4 are electrically coupled to the four enable interfaces EN1, EN2, EN3 and EN4, respectively.

When the server system 1 is in operation, the stored heat dissipation solution in the controller 120 controls the at least one fan 160 to work to cool the rack server 20, and the detection program starts execution simultaneously. The controller 120 detects whether the stored heat dissipation solution matches with each server 220 using the detection program simultaneously, now the controller 120 detects whether the stored heat dissipation solution matches with the server S1 is depicted only. The detection program controls the controller 120 to read a data bit of a register of the server S1, which indicates the server 220 type. When the data bit of the register in server S1 is an effective value, for example logic “1”, the controller 120 determines the stored heat dissipation solution does not match with the server S1. Then, the controller 120 outputs a control signal to the enable interface EN1 via the GPIO interface GPIO1. The control signal controls the USB interface USB2 of the USB converter 140 to be switched on, thus the USB interface of the server S1 connects to the USB interface of the controller 120 via the USB interface USB2 and the USB interface USB1 of the USB converter 140. Then the server S1 writes an updated heat dissipation solution to the controller 120.

In another embodiment, the server 220 can connect to a plurality terminals, for example a computer, a notebook and a smart phone. To set the data bit of the register in the server 220 to the effective value, the heat dissipation solution stored in the controller 120 is updated, thus user can update the heat dissipation solution remotely.

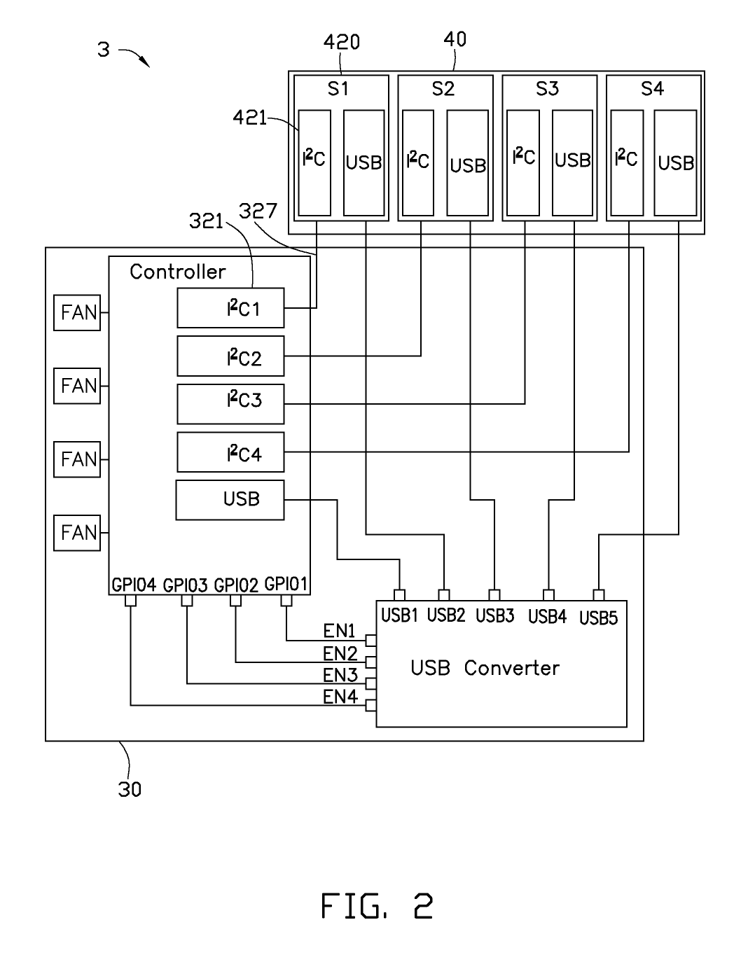

FIG. 2 illustrates a server system 3 according to another exemplary embodiment of present disclosure. A rack server 40 and a heat dissipation system 30 of this embodiment are similar to the rack server 20 and the heat dissipation system 10. However, differences are in that: each server 420 includes an Intelligent Platform Management Bus (IPMB) interface 421, and a controller 320 of the heat dissipation system 30 correspondingly includes four IPMB interfaces 321. Each IPMB interface 321 of the controller 320 is electrically connected to a corresponding IPMB interface 420 of the server 420 via an IPMB bus 327.

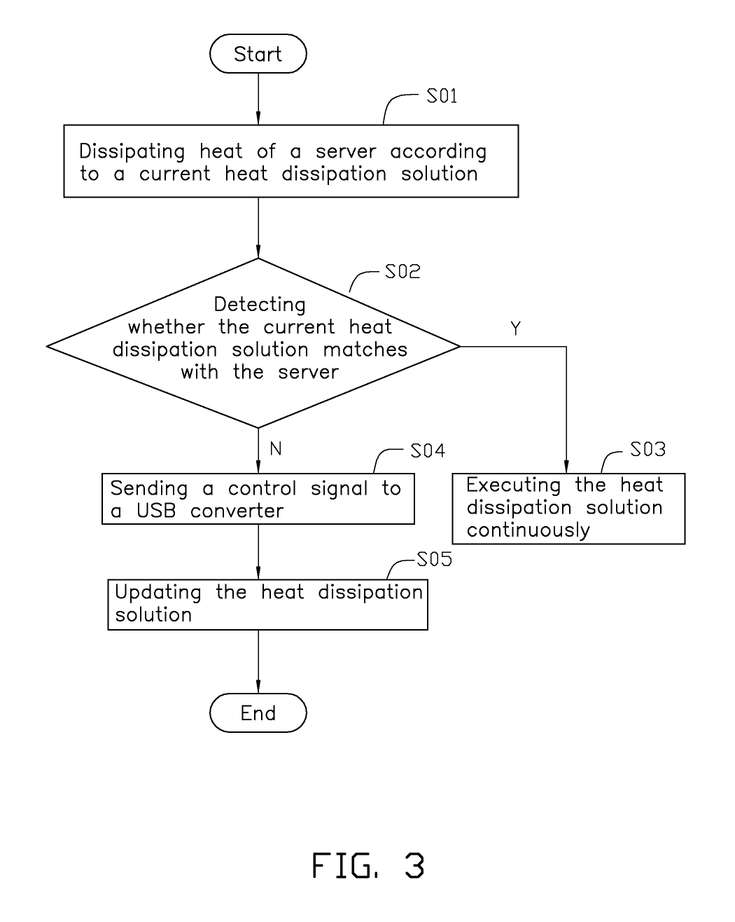

Referring to FIG. 3, a flowchart showing a method for controlling of the server system of present disclosure of FIG. 1. The method includes the following steps, but it should be understood that in other embodiments, additional steps may be added, others deleted, and the ordering of the steps may be changed.

In step S01, the server system 1 is in operation. The heat dissipation system 10 controls the corresponding fan 160 to dissipate heat of the at least one server 220 in the rack server 20 according to a stored heat dissipation solution stored in the controller 120.

In step S02, the controller 120 detects whether the stored heat dissipation solution matches with the server S1. The controller 120 detects whether the stored heat dissipation solution matches with each server 220 simultaneously, now the controller 120 detects whether the stored heat dissipation solution matches with the server S1 is depicted only.

In step S03, the controller 120 controls the corresponding fan 160 to execute the stored heat dissipation solution continuously when the stored heat dissipation solution matches the server S1.

In step S04, the controller 120 sends a control signal to the USB converter 140 when the stored heat dissipation solution matches with the server S1. The control signal controls the USB interface USB2 of the USB converter 140 to be turned on, and therefore the first USB interface 223 of the server S1 connects to the second USB interface 123 of the controller 120 via the USB converter 140. When the communication connection between the first USB interface 223 of the server S1 and the second USB interface 123 of the controller 120 is enabled, the step S05 is performed.

In step S05, the server S1 updates the heat dissipation solution stored in the controller 120 to match the server S1. The server S1 writes an updated heat dissipation solution stored in the server S1 to the controller 120 via the USB converter 140.

In summary, when the heat dissipation solution stored in the controller is not matched with the server, the heat dissipation solution is updated automatically. Therefore the cooling efficiency and the maintainability of the server system are improved.

It is to be understood that even though numerous characteristics and advantages of the present embodiments have been set forth in the foregoing description, with details of the structures and functions of the embodiments, the disclosure is illustrative only; and that changes may be in detail, especially in the matters of arrangement of parts within the principles of the embodiments to the full extent indicated by the broad general meaning of the terms in which the appended claims are expressed.

What is claimed is:

1. A server system, comprising:
a rack server comprising at least one server; and
a heat dissipation system comprising:
at least one fan;
a controller electrically connected to the at least one server and storing at least one heat dissipation solution and a detection program, wherein one heat dissipation solution corresponds to one fan and one server, the controller controls a rotate speed of the at least one fan according to a corresponding heat dissipation solution; and
a USB converter configured to construct a communication connection between the at least one server and the controller;
wherein the controller further detects whether a heat dissipation solution matches with a type of the at least one server using the detection program, and when the controller determines the heat dissipation solution does not match with the type of the at least one server, the USB converter enables the communication connection between a corresponding server and the controller, and the corresponding server writes an updated heat dissipation solution to the controller via the USB converter.

2. The server system of claim 1, wherein the at least one server comprises an I²C interface and a first USB interface, the I²C interface corresponding to a register of the at least one each server to indicate the type of the at least one server.

3. The server system of claim 2, wherein the register comprises a data bit, and the controller determines whether the heat dissipation solution matches with type of the at least one server according to the data bit of the register.

4. The server system of claim 3, wherein if the data bit is logic “1”, the heat dissipation solution does not match with the at least one server.

5. The server system of claim 2, wherein the controller comprises at least one Inter-Integrated Circuit (I²C) interface, at least one General Purpose Input Output (GPIO) interface and a second USB interface.

6. The server system of claim 5, wherein each I²C interface of the controller is electrically connected to the I²C interface of the at least one server respectively via a corresponding an I²C bus line of the I²C interface.

7. The server system of claim 6, wherein the USB converter comprises a plurality of USB interfaces and a plurality of enable interfaces, one of the USB interfaces connected to the second USB interface and the other USB interfaces connected to the USB interface of each of the at least one server respectively; and each GPIO interface connected to the enable interface of the USB converter.

8. The server system of claim 7, wherein when the stored heat dissipation solution does not match with one of the at least one server, the controller outputs a control signal to a corresponding enable interface of the USB converter via a corresponding GPIO interface, the USB converter enables the communication connection between the first USB interface of the corresponding server and the second USB interface of the controller, and the corresponding server writes an updated heat dissipation solution to the controller.

9. The system of claim 1, wherein each of the at least one server comprises an Intelligent Platform Management Bus (IPMB) interface and a USB interface, the IPMB interface corresponds to a register of the at least one server and each IPMB interface of the controller is connected to the IPMB interface of the at least one server successively via a corresponding IPMB bus line.

10. The server system of claim 9, wherein the controller comprises at least one Intelligent Platform Management Bus (IPMB) interface, at least one GPIO interface and a USB interface.

11. A control method for heat dissipation solution of the server system, comprising:
detecting whether the stored heat dissipation solution matches with a server using a detection program;
executing the stored heat dissipation solution continuously when the heat dissipation solution matches with the server;
outputting a control signal to update the heat dissipation solution when the heat dissipation does not match with the server; and
updating the heat dissipation solution by the server.

12. The control method for heat dissipation solution of the server system of claim 11, wherein the heat dissipation solution is stored in a controller.

13. The control method for heat dissipation solution of the server system of claim 12, the detection program is stored in the controller.

14. The control method for heat dissipation solution of the server system of claim 13, wherein the controller sends the control signal to a USB converter when the stored heat dissipation solution does not match with the server; the USB converter enables the communication connection between the controller and the server.
